(19) United States
(12) Patent Application Publication
(10) Pub. No.: US 2003/0083094 A1
(43) Pub. Date: May 1, 2003

(54) Enclosure for portable electronic device and method for making same

(76) Inventors: Che-Yuan Hsu, Tu-Chen (TW); Cheng-Wen Su, Tu-Chen (TW); Chin-Feng Cheng, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/091,765

(22) Filed: Mar. 4, 2002

(30) Foreign Application Priority Data
Oct. 26, 2001 (TW) 90126655

(51) Int. Cl. H04M 1/00

(52) U.S. Cl. 455/550

(57) ABSTRACT

An enclosure (1) for a portable electronic includes a skin (2) made of soft material, a plastic film layer (3), and a base resin layer (4). The skin is on an outer surface of the enclosure. The plastic film layer is between the skin and the base resin layer. A method for making the enclosure includes the steps of: (a) providing a skin made of soft material and a plastic film layer; (b) combining the skin and the plastic film layer together by heat pressing to obtain a preform (5); (c) positioning the preform in a cavity (91) of a mold (9); (d) injecting molten resin into the mold on a surface of the plastic film layer opposite from the skin to obtain the enclosure; and (e) removing the enclosure from the cavity after the resin is cooled and solidified. The enclosure having a unique attractive visual effect and comfortable feel is thus obtained.

### BACKGROUND OF THE INVENTION

1. Field of the Invention

The present invention relates to an enclosure for a portable electronic device and a method for making the same, and particularly to an enclosure having a skin made of soft material such as fabric or leather.

2. Related Art

With the development of information technology, portable electronic devices such as mobile phones and personal digital assistants (PDAs) have become very popular. An attractive appearance and a comfortable feel of such electronic devices are sometimes decisive factors that influence a customer to purchase them. Plastic material has many advantages such as light-weight, low-cost, ease of manufacture, corrosion-resistance and so on. Therefore, enclosures of most portable electronic devices are made of plastic material. To enable plastic enclosures to have an attractive appearance, they are subjected to further processing such as electroplating and lacquering after initial injection molding. U.S. Pat. No. 4,350,739 discloses a process for producing a molded plastic part which may be used as an enclosure for a telephone. However, the plastic part has a hard and cold feel and is unremarkable in appearance.

U.S. Pat. No. 5,123,988 discloses a process for producing a rubber extruded article having a cloth-like surface adhered to a rubber base via an adhesive layer. An enclosure formed to include the article can have a cloth-like surface. However, the process is complicated and costly. Moreover, after prolonged use, the adhesive layer can degenerate and allow the cloth-like surface to separate from the rubber.

Accordingly, an improved enclosure which overcomes the above-mentioned problems is desired.

### SUMMARY OF THE INVENTION

An object of the present invention is to provide an enclosure for a portable electronic device and a method for making the same, the enclosure having a skin made of soft material such as fabric or leather.

Another object of the present invention is to provide an enclosure for a portable electronic device and a method for making the same, the enclosure being easy to manufacture.

To achieve the above objects, an enclosure for a portable electronic device according to the present invention includes a skin made of soft material, a plastic film layer, and a base resin layer. The skin is on an outer surface of the enclosure, the plastic film layer is between the skin and the base resin layer. The skin may be fabric or leather. A method for making the enclosure according to the present invention comprises the steps of: (a) providing a skin made of soft material and a plastic film layer; (b) combining the skin and the plastic film layer together by heat pressing to obtain a preform; (c) positioning the preform in a cavity of a mold; (d) injecting molten resin into said mold on a surface of the plastic film layer that is opposite from the skin to obtain the enclosure; and (e) removing the enclosure from the cavity after the resin is cooled and solidified. The enclosure having a unique attractive visual effect and comfortable feel is thus obtained.

These and additional objects, features and advantages of the present invention will become more apparent after reading the following detailed description of a preferred embodiment of the invention taken in conjunction with the appended drawings, in which:

### BRIEF DESCRIPTION OF THE DRAWINGS

FIG. 1 is a cross-sectional view of a mobile phone having an enclosure according to the present invention;

FIG. 2 is a schematic cross-sectional view showing formation of a perform of the enclosure according to the present invention;

FIG. 3 is a schematic cross-sectional view showing injection of base resin onto the perform of FIG. 2 to form the enclosure according to the present invention; and

FIG. 4 is a cross-sectional view of part of the enclosure according to the present invention.

### DETAILED DESCRIPTION OF THE INVENTION

FIG. 4 is a cross-sectional view of an enclosure for a mobile phone according to a preferred embodiment of the present invention. The enclosure 1 comprises a skin 2 made of soft material such as fabric or leather, a plastic film layer 3, and a base resin layer 4. The skin 2 is on an outer surface of the enclosure 1, and the plastic film layer 3 is disposed between the skin 2 and the base resin layer 4. In the preferred embodiment, the skin 2 is made of a cloth having decorative patterns thereon. The cloth can withstand a temperatures within a range of 80° C. to 120° C. To make sure that the base resin layer 4 and the plastic film layer 3 can be bonded together by heat fusing, the base resin layer 4 has a melting point which is higher than that of the plastic film layer 3. The material for forming the plastic film layer 3 has a melting point in the range of 80° C. to 120° C. In the preferred embodiment, the plastic film layer 3 is made of polyamide. The base resin layer is made of Acrylonitrile-butadiene-styrene (ABS) resin.

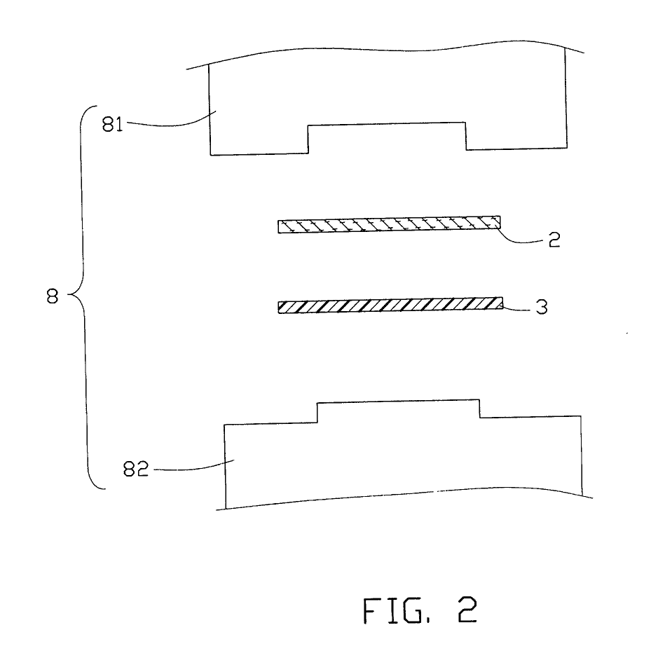

Referring to FIG. 2, in forming the enclosure 1, the skin 2 and the plastic film layer 3 are first subjected to heat pressing using a heat-pressing machine 8. The heat-pressing machine 8 includes an upper mold half 81 defining a cavity (not labeled) and a lower mold half 82 having a protrusion (not labeled). The skin 2 and the plastic film layer 3 are put between the upper and lower mold halves 81, 82 such that the skin 2 is located near the upper mold half 81.

The upper mold half 81 of the heat-pressing machine 8 is then driven to move downwardly toward the lower mold half 82 to a position where the skin 2, the plastic film layer 3 and the protrusion of the lower mold half 82 are fitted in the cavity of the upper mold half 81 under pressure. The skin 2 and the plastic film layer 3 are then subjected to heat pressing at a temperature of 120° C. for 5 to 10 minutes. The skin 2 and the plastic film layer 3 are thus firmly secured together to form a preform 5.

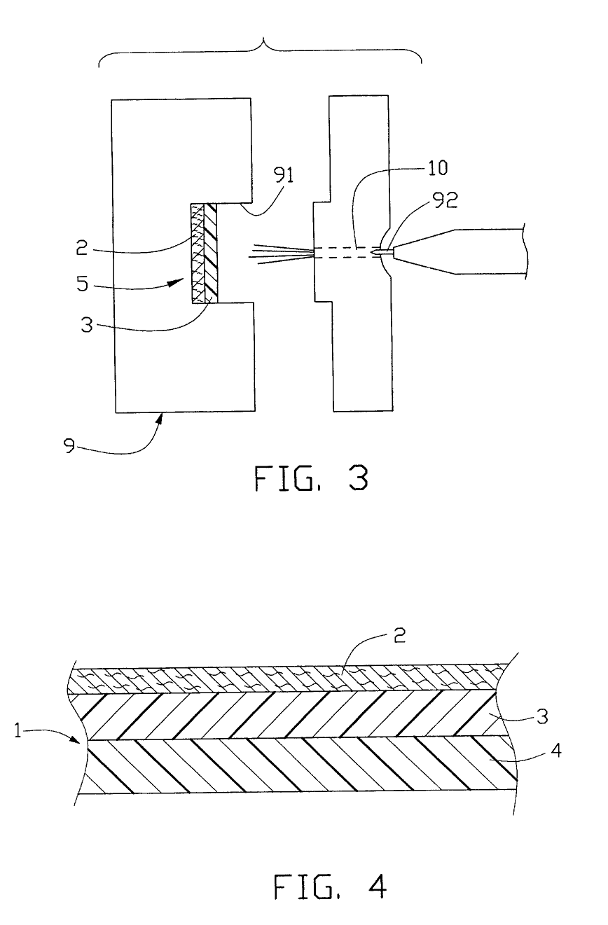

Referring to FIG. 3, the preform 5 is then put in a cavity 91 of a mold 9. Molten ABS resin for forming the base resin layer 4 is then injected into the cavity 91 on a face of the plastic film layer 3 that is opposite from the skin 2. A nozzle 92 is used to inject the molten ABS resin which flows through a passage 10 defined in a mold 9 into the cavity 91. The ABS resin is injected under a pressure in the range of 110 Megapascals (Mpa) to 140 Mpa. The ABS resin cools and solidifies to form the base resin layer 4. The enclosure 1 having a soft outer face is thus formed in the cavity 91. The enclosure 1 has a unique attractive visual effect and is comfortable to touch. If the skin 2 is made of leather, the enclosure 1 similarly has a unique attractive visual effect and is comfortable to touch.

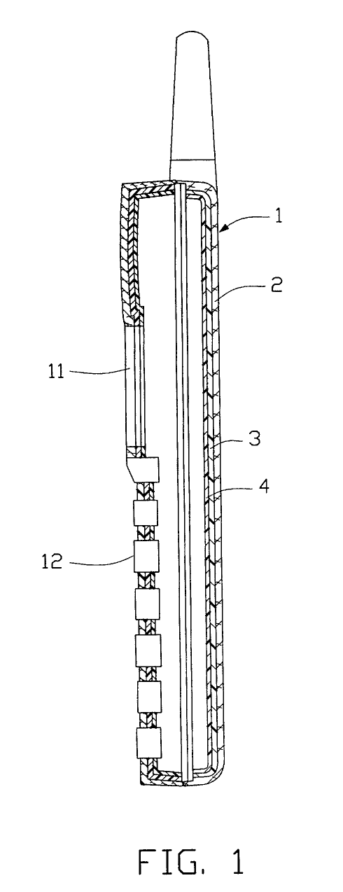

FIG. 1 shows a mobile phone having an enclosure 1 according to the present invention. The mobile phone includes a display screen 11, a keypad 12, and a printed circuit board (PCB,—not shown). The enclosure 1 can be readily adapted to be used for other devices such as PDAs (personal digital assistants).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

I claim:

1. A method for manufacturing an enclosure for a portable electronic device, comprising the steps of:
(a) providing a skin, which is made of soft material, and a plastic film layer;
(b) combining the skin and the plastic film layer together to obtain a preform;
(c) positioning the preform in a cavity of a mold;
(d) injecting molten resin into said mold on a surface of the plastic film layer that is opposite from the skin to obtain the enclosure; and
(e) removing the enclosure from the cavity after the resin is cooled and solidified.

2. The method of claim 1, wherein in step (b) the skin and the plastic film are combined together by heat pressing.

3. The method of claim 2, wherein in step (b) the heat pressing is performed at a temperature in the range of 80 degrees Centigrade to 120 degrees Centigrade.

4. The method of claim 3, wherein in step (b) the heat pressing is performed for a period in the range of 5 to 10 minutes.

5. The method of claim 1, wherein in step (d) the molten resin is injected under a pressure in the range of 110 Megapascals to 140 Megapascals.

6. The method of claim 1, wherein the soft material is cloth.

7. The method of claim 1, wherein the soft material is leather.

8. The enclosure of claim 1, wherein the molten resin has a melting point which is higher than that of the plastic film layer.

9. The enclosure of claim 1, wherein the plastic film layer is made of polyamide.

10. The method of claim 1, wherein the molten resin is molten Acrylonitrile-butadiene-styrene (ABS) resin.

11. An enclosure for a portable electronic device, the enclosure comprising:
a skin;
a plastic film layer; and
a base resin layer,
wherein the skin is on an outer surface of the enclosure, the plastic film layer is between the skin and the base resin layer, and the skin is selected from a group consisting of fabric and leather.

12. The enclosure of claim 11, wherein the base resin layer has a melting point which is higher than that of the plastic film layer.

13. The enclosure of claim 12, wherein the plastic film layer is made of polyamide.

14. The enclosure of claim 12, wherein the base resin layer is made of Acrylonitrile-butadiene-styrene (ABS) resin.

15. The enclosure of claim 12, wherein the skin is made of soft material in comparison with the base resin layer.

16. A portable electronic device, comprising:
an enclosure, comprising an outer layer, a middle layer and an inner layer, the outer layer being made of soft material, the middle layer being a plastic film layer and the inner layer being a base resin layer;
a printed circuit board positioned in the enclosure;
a display screen fitted on the enclosure for showing information, and
a keypad fitted on the enclosure for inputting instructions.

17. The portable electronic device of claim 16 wherein the portable electronic device is a mobile phone.

18. The portable electronic device of claim 16 wherein the portable electronic device is a personal digital assistant.
